(19) United States
(12) Patent Application Publication
(10) Pub. No.: US 2026/0087482 A1
(43) Pub. Date: Mar. 26, 2026

(54) Replay Attack Preventtion System

(71) Applicant: Bank of America Corporation, Charlotte, NC (US)

(72) Inventors: Maneesh Kumar Sethia, Hyderabad (IN); Abhijit Behera, Hyderabad (IN)

(73) Assignee: Bank of America Corporation, Charlotte, NC (US)

(21) Appl. No.: 18/894,368

(22) Filed: Sep. 24, 2024

(51) Int. Cl. G06Q 20/32; G06Q 20/38

(52) U.S. Cl. CPC G06Q 20/3278; G06Q 20/3825; G06Q 20/389

(57) ABSTRACT

Various aspects of the disclosure relate to a smart contract-based security system for near field communication (NFC) data transactions. An NFC data transaction initiated by a first computing device generates a transaction token used to complete the NFC data transaction with a second computing device via an NFC communication link between the two devices. The transaction token is communicated to a remote device with transaction information, where the transaction information may be embedded with the transaction token. The transaction token is processed via smart contract operation to analyze the transaction token to determine whether the token is valid. If valid, the smart contract triggers completion of the data transaction. If invalid, the data transaction is inhibited by the smart contract. Once processed, the smart contract modifies transaction parameters and generates a stale token.

### BACKGROUND

As consumer payment methods change, more consumers desire the flexibility and convenience of contactless payments, such as via use of near-field communication (NFC)-based payments. Indeed, with the integration of NFC hardware into modern portable devices, such as mobile phones, use of NFC-based payments are on the rise. Due to the wireless aspects of NFC-enabled systems, NFC-based payments may be exposed to interception with malicious intent, such as for use in session replay attacks. In a session replay attack, the information captured that is used to execute a particular transaction in a session may be “replayed” (at least) for a second time to defraud a user with a second transaction. For a “replay attack” the malicious actor intercepts the valid transaction data and re-transmits the data to the intended recipient multiple times to cause unwanted actions and/or to gain unauthorized access.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different products and services offered by an organization (e.g., a financial institution, and the like).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes securing NFC transaction information from unauthorized reuse.

Aspects of the disclosure relate to computer hardware and software. In particular, one or more aspects of the disclosure generally relate to computer hardware and software for enabling secure one-time use of NFC-based transaction information. Electronic transactions between parties may be initiated via multiple channels, such as an NFC connection between computing devices. Systems and methods for securing such NFC-based transactions includes modifying token information including sender information and payment information will be staled immediately after the payment is processed.

An illustrative process begins with an NFC payment being initiated, where a data packet containing all the sender details and payment details is transmitted over an NFC communication link. The receiving computing device receives the payment and the transaction completes. To avoid replay attack the token may be made stale after the transaction completes. As soon as the payment is initiated, a smart contract (e.g., at a financial institution) may be triggered. The smart contract ensures that the token is staled immediately after the payment. Once the token becomes stale, even if the session replay attack happens, the any payment attempt using that token fails. As part of the staling process of the token, the parameters which were used during the initial successful transaction are then invalidated. This ensures the attack fails with the stale token. and ensures and/or protects all NFC-based payments from replay attack susceptibility. For example, the replay attack prevention system may be used to protect all NFC payment types including, for example, mobile to mobile NFC transactions, mobile to point of sale (POS) transactions, Mobile to automated teller machine (ATM) transactions, passive card to POS transactions, passive card to ATM transactions, and/or the like.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for securing near-field communication (NFC)-based payments and other transactions, in accordance with one or more aspects described herein;

FIG. 1B shows an illustrative computing platform enabled for NFC-based payments, in accordance with one or more aspects described herein;

FIG. 2 shows illustrative platforms for performing NFC-based transactions in accordance with one or more aspects described herein;

FIG. 3 show an illustrative NFC transaction with transaction information susceptibility for interception and reuse in a replay attack, in accordance with one or more aspects described herein;

FIG. 4 shows an illustrative block diagram representation of a replay attack prevention process in accordance with one or more aspects described herein; and

FIG. 5 shows an illustrative process for providing replay attack prevention for NFC-based transactions in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

The replay attack prevention system prevents malicious reuse of locally (or remotely) captured near field communication (NFC) transaction information by ensuring the data packet associated with the NFC-based transaction becomes stale after the transaction is completed. The replay attack prevention system may be integrated within an enterprise organization's computing infrastructure, such as a financial institution's computing network, to prevent replay attacks of captured NFC-based payment transaction information using blockchain, or other distributed leger technology, to cause NFC-based transaction data to become stale, or otherwise obsolete, immediately upon completion of the NFC-based transaction by utilizing techniques to make the data packet stale immediately after payment. For example, a smart contract may be used to ensure and facilitate a staling process for an NFC-based transaction token as part of the token staling process.

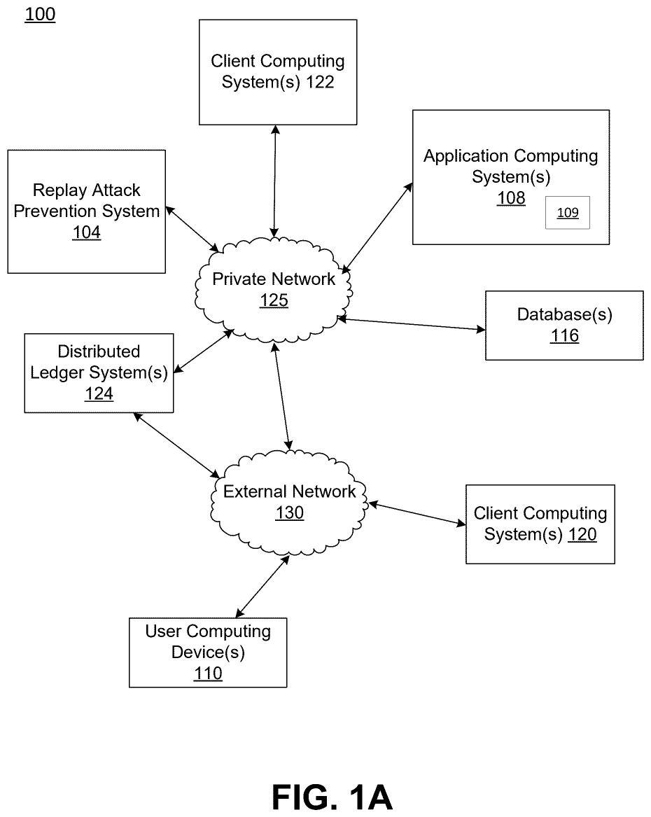

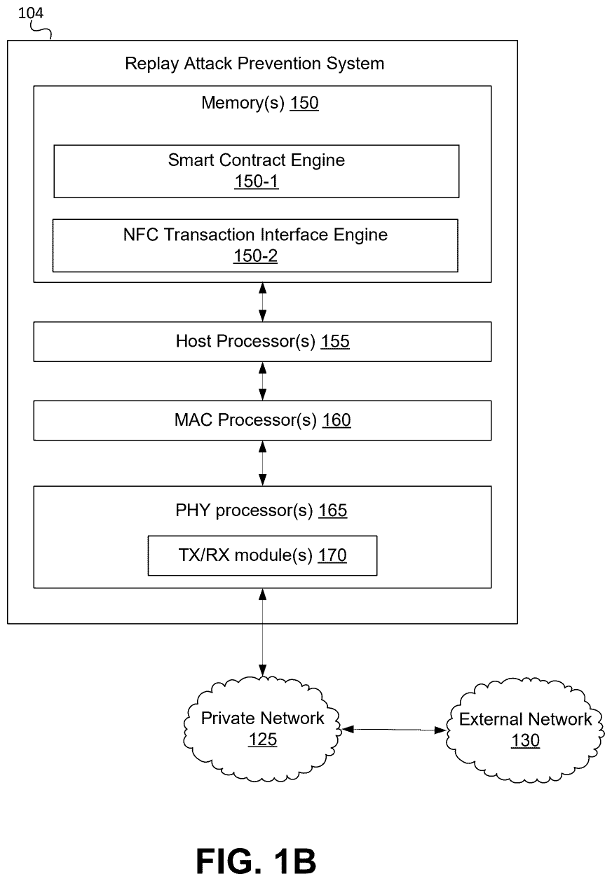

FIG. 1A shows an illustrative computing environment 100 for protecting near-field communication (NFC)-based transactions from malicious use and reuse, in accordance with one or more arrangements. The computing environment 100 may comprise one or more devices (e.g., computer systems, communication devices, and the like). The computing environment 100 may comprise, for example, a replay attack prevention system 104, one or more application computing systems 108, one or more client computing systems 122, and/or one or more database(s) 116. The one or more of the devices and/or systems, may be linked over a private network 125 associated with an enterprise organization (e.g., a financial institution, a business organization, an educational institution, a governmental organization and the like). The computing environment 100 may additionally comprise one or more distributed ledger computing systems 124, one or more client computing systems 120, and one or more user devices 110 connected, via a public network 130, to the devices in the private network 125. The devices in the computing environment 100 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3^{rd} Generation Partnership Project (3GPP) cellular protocol, a hypertext transfer protocol (HTTP), etc.). While FIG. 1A shows the replay attack prevention system 104, as a separate computing system, aspects of the replay attack prevention system 104 may be implemented within one or more different computing systems, such as the application computing systems 108 and/or the distributed ledger computing system 124.

The replay attack prevention system 104 may comprise one or more computing devices and/or other computer components (e.g., processors, memories, communication interfaces) configured to perform one or more functions as described herein. Further details associated with the architecture of the replay attack prevention system 104 are described with reference to FIG. 1B.

The application computing systems 108 and/or the client computing systems 122 may comprise one or more computing devices and/or other computer components (e.g., processors, memories, communication interfaces). In addition, the application computing systems 108 and/or the client computing systems 122 may be configured to host, execute, and/or otherwise provide one or more enterprise applications. In some cases, the application computing systems 108 may host one or more services 109 configured facilitate operations requested through one or more API calls, such as data retrieval and/or initiating processing of specified functionality. In some cases, the client computing systems 122 may be configured to communicate with one or more of the application computing systems 108 such as via direct communications and/or API function calls and the services 109. In an arrangement where the private network 125 is associated with a financial institution (e.g., a bank), the application computing systems 108 may be configured, for example, to host, execute, and/or otherwise provide one or more transaction processing programs, such as an online banking application, fund transfer applications, and/or other programs associated with the financial institution. The client computing systems 122 and/or the application computing systems 108 may comprise various servers and/or databases that store and/or otherwise maintain account information, such as financial account information including account balances, transaction history, account owner information, and/or other information. In addition, the client computing systems 122 and/or the application computing systems 108 may process and/or otherwise execute transactions on specific accounts based on commands and/or other information received from other computer systems comprising the computing environment 100. In some cases, one or more of the client computing systems 122 and/or the application computing systems 108 may be configured, for example, to host, execute, and/or otherwise provide one or more transaction processing programs, such as electronic fund transfer applications, online loan processing applications, and/or other programs associated with the financial institution.

The application computing systems 108 may be one or more host devices (e.g., a workstation, a server, and the like) or mobile computing devices (e.g., smartphone, tablet). In addition, an application computing systems 108 may be linked to and/or operated by a specific enterprise user (who may, for example, be an employee or other affiliate of the enterprise organization) who may have administrative privileges to perform various operations within the private network 125. In some cases, the application computing systems 108 may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights.

The client computing systems 120 may comprise one or more computing devices and/or other computer components (e.g., processors, memories, communication interfaces). The client computing systems 120 may be configured, for example, to host, execute, and/or otherwise provide one or more transaction processing programs, such as goods ordering applications, electronic fund transfer applications, online loan processing applications, and/or other programs associated with providing a product or service to a user. With reference to the example where the client computing systems 120 is for processing an electronic exchange of goods and/or services. The client computing systems 120 may be associated with a specific goods purchasing activity, such as purchasing a vehicle, transferring title of real estate may perform communicate with one or more other platforms within the client computing systems 120. In some cases, the client computing systems 120 may integrate API calls to request data, initiate functionality, or otherwise communicate with the one or more application computing systems 108, such as via the services 109. For example, the services 109 may be configured to facilitate data communications (e.g., data gathering functions, data writing functions, and the like) between the client computing systems 120 and the one or more application computing systems 108.

The user device(s) 110 may be computing devices (e.g., desktop computers, laptop computers) or mobile computing device (e.g., smartphones, tablets) connected to the private network 125. The user device(s) 110 may be configured to enable the user to access the various functionalities provided by the devices, applications, and/or systems in the private network 125. In some cases, the user devices 110 may be configured to or otherwise be enabled to communicate via near-field communication hardware with one or more other computing devices, such as other user devices to facilitate a person to person NFC-based transaction and/or a third-party computing device, such as a computing device of the client computing systems 122, the client computing systems 120, and/or the application computing devices to complete an NFC-based transaction. In some cases, one or more of the aforementioned NFC-enabled computing devices may be capable of facilitating an NFC-based transaction with a passive NFC-enabled device, such as an NFC-enabled card.

The database(s) 116 may comprise one or more computer-readable memories storing information that may be used by the replay attack prevention system 104. For example, the database(s) 116 may store instructions that enable smart contract operation to perform staling actions on NFC tokens, and the like. In an arrangement, the database(s) 116 may be used for other purposes as described herein. In some cases, the client computing systems 120 may write data or read data to the database(s) 116 via the services 109.

The decentralized ledger computing system 124 provided herein is described, at least in part, in relation to a decentralized peer-to-peer (e.g., P2P) system specialized for the purpose of managing a blockchain and/or other distributed ledger structure. The decentralized P2P system may be comprised of computing devices that are distributed in multiple locations across a geographical area as opposed to a single location. The computing devices forming the decentralized P2P system may operate with each other to manage a blockchain, which may be a data structure used to store information related to the decentralized P2P system. More specifically, the blockchain may be a chronological linkage of data elements (e.g., blocks) which store data records relating to the decentralized computing system.

A user, such as an individual, an application, and/or a computing system, may access the decentralized P2P system through a specialized “wallet” or other data structure that serves to uniquely identify the user and enable the user to perform functions related to the decentralized P2P network. Through the wallet, the user may be able to hold tokens, funds, process rules and/or associated computing functionality and/or any other asset associated with the decentralized P2P system. Furthermore, the user may be able to use the wallet to request performance of network-specific functions related to the decentralized P2P system such as rule processing, data, fund, token, and/or asset transfers, and/or the like. The various computing devices forming the decentralized P2P computing system may operate as a team to perform network-specific functions requested by the user. In performing the network-specific functions, the various computing devices may produce blocks that store the data generated during the performance of the network-specific functions and may add the blocks to the blockchain. After the block has been added to the blockchain, the wallet associated with the user may indicate that the requested network-specific function has been performed.

For example, a user may have a wallet which reflects that the user has five tokens associated with the decentralized P2P system. The user may provide a request to the decentralized P2P system to transfer the five tokens to a friend who also has a wallet. The various computing devices forming the decentralized P2P computing system may perform the request and transfer the five tokens from the wallet of the user to the wallet of the friend. In doing so, a block may be created by the various computing devices of the decentralized P2P computing system. The block may store data indicating that the five tokens were transferred from the wallet of the user to the wallet of the friend. The various computing devices may add the block to the blockchain. At such a point, the wallet of the user may reflect the transfer of the five tokens to the wallet of the friend, and may indicate a balance of zero. The wallet of the friend, however, may also reflect the transfer of the five tokens and may have a balance of five tokens. Similarly, additionally to and/or in place of transferring data (e.g., the tokens), the wallets may process functions associated with data transfer rules (e.g., business rules, data security policies, and/or the like.

In more detail, the decentralized P2P system may be specialized for the purpose of managing a distributed ledger, such as a private blockchain or a public blockchain, through the implementation of digital cryptographic hash functions, consensus algorithms, digital signature information, and network-specific protocols and commands. The decentralized P2P system (e.g., decentralized system) may be comprised of decentralized system infrastructure consisting of a plurality computing devices, either of a heterogeneous or homogenous type, which serve as network nodes (e.g., full nodes and/or lightweight nodes) to create and sustain a decentralized P2P network (e.g., a decentralized network such as the computing environment 100 and/or the distributed ledger computing systems 124). Each of the full network nodes may have a complete replica or copy of a blockchain stored in memory and may operate in concert, based on the digital cryptographic hash functions, consensus algorithms, digital signature information, and network-specific protocols, to execute network functions and/or maintain inter-nodal agreement as to the state of the blockchain. Each of the lightweight network nodes may have at least a partial replica or copy of the blockchain stored in memory and may request performance of network functions through the usage of digital signature information, hash functions, and network commands. In executing network functions of the decentralized network, such as balance sheet transactions and smart contract operations, at least a portion of the full nodes forming the decentralized network may execute the one or more cryptographic hash functions, consensus algorithms, and network-specific protocols to register a requested network function on the blockchain. In some instances, a plurality of network function requests may be broadcasted across at least a portion of the full nodes of the decentralized network and aggregated through execution of the one or more digital cryptographic hash functions and by performance of the one or more consensus algorithms to generate a single work unit (e.g., block), which may be added in a time-based, chronological manner to the blockchain through performance of network-specific protocols.

While in practice the term “blockchain” may hold a variety of contextually derived meanings, the term blockchain, as used herein, refers to a concatenation of sequentially dependent data elements (e.g., blocks) acting as a data ledger that stores records relating to a decentralized computing system. Such data records may be related to those used by a particular entity or enterprise, such as a financial institution, and/or may be associated with a particular application and/or use case including, but not limited to, cryptocurrency, digital content storage and delivery, entity authentication and authorization, digital identity, marketplace creation and operation, internet of things (IoT), prediction platforms, balloting activities, health information, currency exchange and remittance, P2P transfers, ride sharing, electronic entertainment, trading platforms, and real estate, precious metal, and work of art registration and transference, among others. A “private blockchain” may refer to a blockchain of a decentralized private system in which only authorized computing devices are permitted to act as nodes in a decentralized private network and have access to the private blockchain. In some instances, the private blockchain may be viewable and/or accessible by authorized computing devices which are not participating as nodes within the decentralized private network, but still have proper credentials. A “public blockchain” may refer to a blockchain of a decentralized public system in which any computing devices may be permitted to act as nodes in a decentralized public network and have access to the public blockchain. In some instances, the public blockchain may be viewable and/or accessible by computing devices which are not participating as nodes within the decentralized public network.

Further, a “full node” or “full node computing device,” as used herein, may describe a computing device in a decentralized system which operates to create and maintain a decentralized network, execute requested network functions, and maintain inter-nodal agreement as to the state of the blockchain. In order to perform such responsibilities, a computing device operating as a full node in the decentralized system may have a complete replica or copy of the blockchain stored in memory, as well as executable instructions for the execution of hash functions, consensus algorithms, digital signature information, network protocols, and network commands. A “lightweight node,” “light node,” “lightweight node computing device,” or “light node computing device” may refer to a computing device in a decentralized system, which operates to request performance of network functions (e.g., balance sheet transactions, smart contract operations, and the like) within a decentralized network but without the capacity to execute requested network functions and maintain inter-nodal agreement as to the state of the blockchain. As such, a computing device operating as a lightweight node in the decentralized system may have a partial replica or copy of the blockchain. In some instances, network functions requested by lightweight nodes to be performed by the decentralized network may also be able to be requested by full nodes in the decentralized system.

“Network functions” and/or “network-specific functions,” as described herein, may relate to functions which are able to be performed by nodes of a decentralized P2P network. In some arrangements, the data generated in performing network-specific functions may or may not be stored on a blockchain associated with the decentralized P2P network. Examples of network functions may include “smart contract operations. ” A smart contract operation, as used herein, may describe one or more operations performed by a “smart contract,” which may be one or more algorithms and/or programs associated with one or more nodes within a decentralized P2P network. For example, the one or more algorithms and/or programs may correspond to addition of a NFT-API to a blockchain or querying of NFT-APIs stored in a blockchain. Addition of NFT-APIs may correspond to updating those stored in the blockchain.

In one or more aspects of the disclosure, a “digital cryptographic hash function,” as used herein, may refer to any function which takes an input string of characters (e.g., message), either of a fixed length or non-fixed length, and returns an output string of characters (e.g., hash, hash value, message digest, digital fingerprint, digest, and/or checksum) of a fixed length. Examples of digital cryptographic hash functions may include BLAKE (e.g., BLAKE-256, BLAKE-512, and the like), MD (e.g., MD2, MD4, MD5, and the like), Scrypt, SHA (e.g., SHA-1, SHA-256, SHA-512, and the like), Skein, Spectral Hash, SWIFT, Tiger, and so on. A “consensus algorithm,” as used herein and as described in further detail below, may refer to one or more algorithms for achieving agreement on one or more data values among nodes in a decentralized network. Examples of consensus algorithms may include proof of work (e.g., PoW), proof of stake (e.g., PoS), delegated proof of stake (e.g., DPoS), practical byzantine fault tolerance algorithm (e.g., PBFT), and so on. Furthermore, “digital signature information” may refer to one or more private/public key pairs and digital signature algorithms which are used to digitally sign a message and/or network function request for the purposes of identity and/or authenticity verification. Examples of digital signature algorithms which use private/public key pairs contemplated herein may include public key infrastructure (PKI), Rivest-Shamir-Adleman signature schemes (e.g., RSA), digital signature algorithm (e.g., DSA), Edwards-curve digital signature algorithm, and the like. A “wallet,” as used herein, may refer to one or more data and/or software elements (e.g., digital cryptographic hash functions, digital signature information, and network-specific commands) that allow a node in a decentralized P2P network to interact with the decentralized P2P network. A wallet may be associated with a public key, which may serve to identify the wallet. In requesting performance of network operations, a private key associated with the wallet may be used to digitally sign the network operation requests.

For another example, a first lightweight node computing device may request a smart contract operation related to a decentralized P2P network, which may facilitate a dual data transfer between a wallet associated with the first lightweight node computing device and a wallet associated with another node in the decentralized P2P network, such as the second lightweight node computing device, based on fulfillment of programmatic conditions established by a smart contract. Processors of the first lightweight node computing device may execute network commands to broadcast a smart contract operation network function request to the decentralized P2P network. The smart contract operation network function request may include details about the data transfer such as data type, function operations, and/or amount, as well as a data transfer amount to one or more full node computing devices of the decentralized P2P network for executing the smart contract corresponding to the smart contract operation network function request. The smart contract operation network function request may further include the public key associated with the smart contract. Processors of the first lightweight node computing device may execute digital signature algorithms to digitally sign the smart contract operation network function request with the private key associated with the wallet of the first lightweight node computing device.

At the decentralized P2P network, the smart contract operation network function request may be broadcasted to each of the full node computing devices through execution of network protocols by the full node computing devices. In order to execute the smart contract operation network function request and maintain inter-nodal agreement as to the state of the blockchain (or other distributed ledger structure), processors, ASIC devices, and/or GPUs of the full node computing devices may execute network protocols to receive broadcast of the network function through the decentralized P2P network and from the first lightweight node computing device. Processors, ASIC devices, and/or GPUs of the full node computing devices may execute hash functions to generate a digest of the smart contract operation network function request. The resultant digest of the smart contract operation network function request, in turn, may be hashed with the block hash of the most immediately preceding block of the blockchain. Processors, ASIC devices, and/or GPUs of the full node computing devices may execute consensus algorithms to identify a nonce corresponding to the particular executed consensus algorithm and related to the digest that combines the digest of the smart contract operation network function request and the block hash of the most immediately preceding block of the blockchain.

The identification of the nonce enables processors, ASIC devices, and/or GPUs of the full node computing device from the full node computing devices to create a new block with a block header (e.g., block hash), which is a digest that combines the smart contract operation network function request, the block hash of the most immediately preceding block, and the identified nonce. Processors, ASIC devices, and/or GPUs of the full node computing device from the full node computing devices may execute network protocols to add the new block to the blockchain and broadcast the new block to the other full node computing devices in the decentralized P2P network. In some arrangements, the new block may also be time-stamped at a time corresponding to the addition to the blockchain. Furthermore, as a reward for adding the new block to the blockchain, the full node computing device from the full node computing devices may, per the network protocols, increase a balance sheet holdings amount associated with itself by a predetermined amount. In some arrangements, each of the full node computing devices may receive an equal portion of the data transfer amount specified by the first lightweight node computing device for executing the smart contract operation network function request. After the new block has been added to the blockchain, the smart contract operation request may be considered to be executed and the data transfer from the wallet associated with the first lightweight node computing device to the public key associated with the smart contract may be registered.

The smart contract may be configured to hold the data transfer from the wallet associated with the first lightweight node computing device until fulfillment of certain predetermined criteria hardcoded into the smart contract are achieved. The smart contract may be configured such that it serves as an intermediate arbiter between entities within the decentralized P2P network and may specify details of a dual data transfer between entities perform functionality and/or rules configured in the smart contract, and/or the like.

For example, the smart contract corresponding to the smart contract operation request may be one or more algorithms and/or programs stored on a block of the blockchain. The smart contract may be identified by one or more wallets and/or public keys within the decentralized P2P network. The first lightweight node computing device may transmit the smart contract operation network function request to the decentralized P2P network, which may cause execution of the corresponding smart contract that facilitates a dual data transfer between a wallet associated with the first lightweight node computing device and a wallet associated with another node in the decentralized P2P network, such as the second lightweight node computing device, based on fulfillment of programmatic conditions established by the smart contract. In the processes of adding the block comprising the smart contract operation request to the blockchain, each of the full node computing devices may identify the block within the blockchain comprising the smart contract, associate the data transfer entailed by the smart contract operation request with the smart contract, and execute the one or more algorithms and/or programs of the smart contract. In this instance, given that the smart contract facilitates a dual data transfer and that data transfer has yet to be received from another node (e.g., a lightweight node computing device), each of a plurality of full node computing devices may execute the smart contract without fulfillment of the programmatic conditions established by the smart contract. Accordingly, the funds transferred by the first lightweight node computing device may remain in the smart contract until the data transfer from the other node is also associated with the smart contract.

Moving forward, the second lightweight node computing device may also request a smart contract operation related to the decentralized P2P network, which may conclude the dual data transfer between the wallet associated the second lightweight node computing device and the wallet associated with the first lightweight node computing device. Processors of the second lightweight node computing device may execute network commands to broadcast the smart contract operation network function request to the decentralized P2P network. The smart contract operation network function request may include details about the data transfer such as data type and amount, as well as a data transfer amount to the full node computing devices of the decentralized P2P network for executing the smart contract corresponding to the smart contract operation network function request. The smart contract operation network function request may further include the public key associated with the smart contract. Processors of the second lightweight node computing device may execute digital signature algorithms to digitally sign the smart contract operation network function request with the private key associated with the wallet of the second lightweight node computing device.

At the decentralized P2P network, the smart contract operation network function request may be broadcasted to each of the full node computing devices through execution of network protocols by the full node computing devices. In order to execute the smart contract operation network function request and maintain inter-nodal agreement as to the state of the blockchain, processors, ASIC devices, and/or GPUs of the full node computing devices may execute network protocols to receive broadcast of the network function through the decentralized P2P network and from the second lightweight node computing device. Processors, ASIC devices, and/or GPUs of the full node computing devices may execute hash functions to generate a digest of the smart contract operation network function request. The resultant digest of the smart contract operation network function request, in turn, may be hashed with the block hash of the most immediately preceding block of the blockchain. Processors, ASIC devices, and/or GPUs of the full node computing devices may execute consensus algorithms to identify a nonce corresponding to the particular executed consensus algorithm and related to the digest that combines the digest of the smart contract operation network function request and the block hash of the most immediately preceding block of the blockchain.

The identification of the nonce enables processors, ASIC devices, and/or GPUs of the full node computing device from the full node computing devices to create a new block with a block header (e.g., block hash), which is a digest that combines the smart contract operation network function request, the block hash of the most immediately preceding block, and the identified nonce. Processors, ASIC devices, and/or GPUs of the full node computing device from the full node computing devices may execute network protocols to add the new block to the blockchain and broadcast the new block to the other full node computing devices in the decentralized P2P network. In some arrangements, the new block may also be time-stamped at a time corresponding to the addition to the blockchain. Furthermore, as a reward for adding the new block to the blockchain, the full node computing device from the full node computing devices may be allowed, per the network protocols, to increase a balance sheet holdings amount associated with itself by a predetermined amount. In some arrangements, each of the full node computing devices may receive an equal portion of the data transfer amount specified by the second lightweight node computing device for executing the smart contract operation network function request. After the new block has been added to the blockchain, the smart contract operation transaction network function request may be considered to be executed and the data transfer from the wallet associated with the second lightweight node computing device to the public key associated with the smart contract may be registered.

When the smart contract receives the data value from each of the second lightweight node computing device and the first lightweight node computing device, the execution of the smart contract by each of the full node computing devices may cause transfer of the data value from the second lightweight node computing device to the first lightweight node computing device and the data value from the first lightweight node computing device to the second lightweight node computing device.

For example, the second lightweight node computing device may transmit the smart contract operation network function request to the decentralized P2P network, which may cause execution of the corresponding smart contract that facilitates the dual data transfer. In the process of adding the block comprising the smart contract operation request provided by the second lightweight node computing device to the blockchain, each of the full node computing devices may identify the block within the blockchain comprising the smart contract, associate the data transfer entailed by smart contract operation request of the second lightweight node computing device with the smart contract, and execute the one or more algorithms and/or programs of the smart contract. In this instance, given that the smart contract facilitates a dual data transfer and that data transfers have been received from the second lightweight node computing device and the first lightweight node computing device, each of the full node computing devices may execute the smart contract as fulfillment of the programmatic conditions established by the smart contract has occurred. Accordingly, the funds allocated to the smart contract by each of the second lightweight node computing device and the first lightweight node computing device may be respectively distributed to the intended counterparty.

While the description provided above was made in relation to the second lightweight node computing device and the first lightweight node computing device, it should be understood that any of the full node computing devices and lightweight node computing devices in a decentralized system, such as the distributed ledger computing systems 124 and/or the computing environment 100, may participate in the smart contract. Furthermore, it should be understood that the smart contract may be able to fulfill dual data transfers in the manner described above across a plurality of entities entering into the smart contract. For example, a first plurality of entities may enter into the smart contract, which may hold the data values for each of the first plurality of entities until a second plurality of entities enter into the smart contract. When each of the first plurality of entities and the second plurality of entities have entered, the smart contract may perform the data transfer. Other smart contracts may be included which include algorithms, programs, and/or computer-executable instructions which cause the performance of one or more functions related to at least cryptocurrency, digital content storage and delivery, entity authentication and authorization, digital identity, marketplace creation and operation, internet of things (e.g., IoT), prediction platforms, balloting information, health information, currency exchange and remittance, P2P transfers, ride sharing, electronic information, trading platforms, and real estate, precious metal, and work of art registration and transference.

In one or more arrangements, the replay attack prevention system 104, the application computing systems 108, the client computing systems 120, the client computing systems 122, the digital ledger computing systems 124, the user devices 110, the databases 116, and/or the other devices/systems in the computing environment 100 may be any type of computing device capable of receiving input via a user interface, and communicating the received input to one or more other computing devices in the computing environment 100. For example, the replay attack prevention system 104, the application computing systems 108, the client computing systems 120, the client computing systems 122, the digital ledger computing systems 124, the user devices 110, the databases 116, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the replay attack prevention system 104, the application computing systems 108, the client computing systems 120, the client computing systems 122, the digital ledger computing systems 124, the user devices 110, the databases 116, and/or the other devices/systems in the computing environment 100 may, in some instances, be and/or comprise special-purpose computing devices configured to perform specific functions.

FIG. 1B shows an illustrative replay attack prevention system 104 in accordance with one or more examples described herein. The replay attack prevention system 104 may be a stand-alone device and/or may at least be partial integrated with the development computing system 104may comprise one or more of host processor(s) 155, medium access control (MAC) processor(s) 160, physical layer (PHY) processor(s) 165, transmit/receive (TX/RX) module(s) 170, memory 150, and/or the like. One or more data buses may interconnect host processor(s) 155, MAC processor(s) 160, PHY processor(s) 165, and/or Tx/Rx module(s) 170, and/or memory 150. The replay attack prevention system 104 may be implemented using one or more integrated circuits (ICs), software, or a combination thereof, configured to operate as discussed below. The host processor(s) 155, the MAC processor(s) 160, and the PHY processor(s) 165 may be implemented, at least partially, on a single IC or multiple ICs. The memory 150 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 160 and/or the PHY processor(s) 165 of the replay attack prevention system 104 may be configured to generate data units, and process received data units, that conform to any suitable wired and/or wireless communication protocol. For example, the MAC processor(s) 160 may be configured to implement MAC layer functions, and the PHY processor(s) 165 may be configured to implement PHY layer functions corresponding to the communication protocol. The MAC processor(s) 160 may, for example, generate MAC data units (e.g., MAC protocol data units (MPDUs)), and forward the MAC data units to the PHY processor(s) 165. The PHY processor(s) 165 may, for example, generate PHY data units (e.g., PHY protocol data units (PPDUs)) based on the MAC data units. The generated PHY data units may be transmitted via the TX/RX module(s) 170 over the private network 125. Similarly, the PHY processor(s) 165 may receive PHY data units from the TX/RX module(s) 165, extract MAC data units encapsulated within the PHY data units, and forward the extracted MAC data units to the MAC processor(s). The MAC processor(s) 160 may then process the MAC data units as forwarded by the PHY processor(s) 165.

One or more processors (e.g., the host processor(s) 155, the MAC processor(s) 160, the PHY processor(s) 165, and/or the like) of the replay attack prevention system 104 may be configured to execute machine readable instructions stored in memory 150. The memory 150 may comprise (i) one or more program modules/engines having instructions that when executed by the one or more processors cause the replay attack prevention system 104 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the replay attack prevention system 104 and/or by different computing devices that may form and/or otherwise make up the replay attack prevention system 104. For example, the memory 150 may have, store, and/or comprise a smart contract engine 150-1, a NFC transaction interface engine 150-2, and/or the like. The code testing engine 150-1 may have instructions that direct and/or cause the replay attack prevention system 104 to perform one or more operations associated with managing and/or coordinating smart contract interaction with a transaction computing system, and the like. The NFC transaction engine 150-2 may have instructions that may cause the replay attack prevention system 104 to facilitate coordination of the NFC transaction and connection to the different financial transaction computing systems.

While FIG. 1A illustrates the replay attack prevention system 104, the digital ledger computing systems, and/or the application computing systems 108, as being separate elements connected in the private network 125, in one or more other arrangements, functions of one or more of the above may be integrated in a single device/network of devices. For example, elements in the replay attack prevention system 104 (e.g., host processor(s) 155, memory(s) 150, MAC processor(s) 160, PHY processor(s) 165, TX/RX module(s) 170, and/or one or more program/modules stored in memory(s) 150) may share hardware and software elements with and corresponding to, for example, the digital ledger computing systems 124, and/or the application computing systems 108.

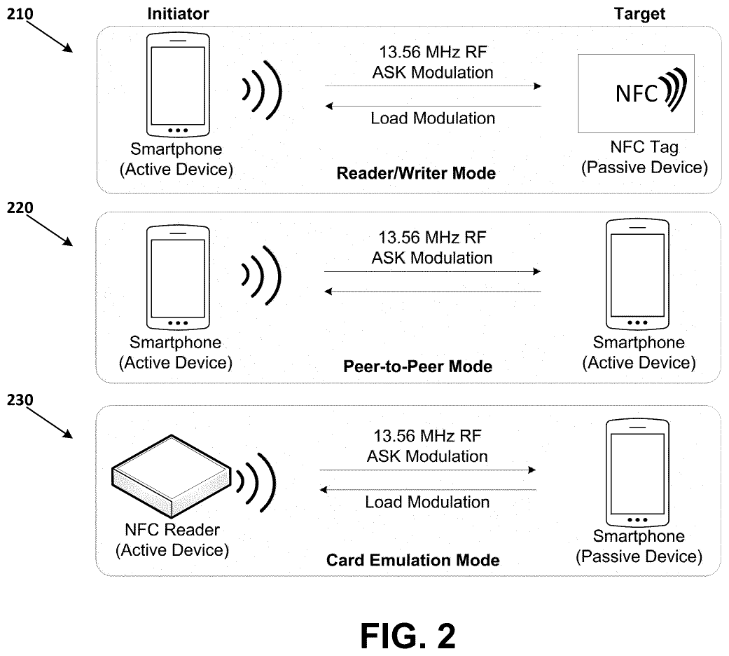

FIG. 2 shows illustrative platforms for performing NFC-based transactions in accordance with one or more aspects described herein. A first NFC network 210 shows an NFC network communication reader/writer mode between an initiator (e.g., a smartphone) as an active device and target (e.g., an NFC tag) as a passive device. A second NFC network 220 shows a peer-to-peer mode between two active devices (e.g., smartphones). A third NFC network 230 shows a card emulation mode between an active device (e.g., an NFC reader) and a passive device (e.g., a smartphone).

In general, NFC communication technologies facilitate wireless communication between different NFC devices within a relatively small distance (e.g., up to about 10 centimeters). The NFC networks 210, 220, and/or 230 may be used for many data communication operations including, but not limited to, payments, data transfer, access control, and/or authentication. For example, NFC communications may be used for payments and other financial transactions. For example, credit cards may include embedded NFC chips that allow users to make contactless payments by placing the NFC enabled cards close to or against an NFC reader. Additionally, smartphones and/or other computing devices may be equipped with NFC technology to enable peer-to-peer transactions with other smartphones and/or other contactless payments with NFC readers. Additionally, NFC technology may be leveraged for other forms of data transfer and/or data sharing. For example, NFC enabled devices may allow users to share data (e.g., photos, music files, contact lists, and/or files and/or data types) between two NFC-enabled devices simply by touching or otherwise placing the devices near each other. Further, NFC communications may be used for other functionality requiring data transfers, such as access control and/or user authentication. For example, enterprise organizations may use NFC enabled cards to control entry or other access to specified locations, such as computer centers or other secure locations. In doing so, NFC enabled cards and/or devices may securely store information, such as passwords, user credentials, and/or the like.

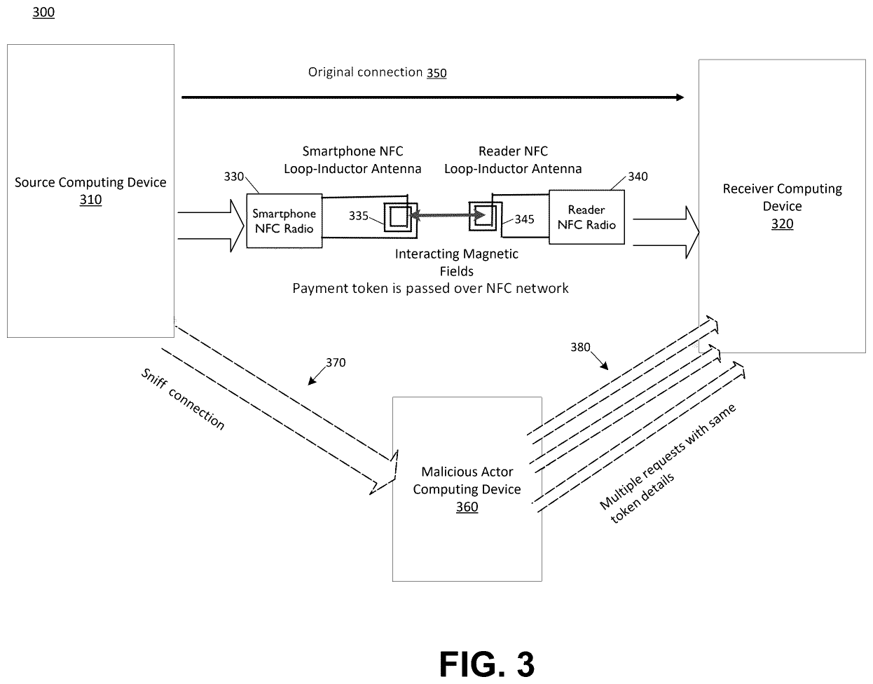

FIG. 3 show an illustrative NFC transaction via an NFC network 300 with transaction information susceptibility for interception and reuse in a replay attack, in accordance with one or more aspects described herein. The NFC network includes a source computing device 310 communicating with a receiver computing device 320 via a connection 350. The connection 350 comprises a near field communication interface supported by, for example, a source computing device NFC radio (e.g., a smartphone NFC radio 330) connected to a first loop inductor antenna 335 to facilitate a wireless communication connection via a second loop inductor antenna 345 and a receiver NFC radio (e.g., a reader NFC radio 340) of the receiver computing device 320. In some cases, the wireless connection between the first loop inductor antenna 335 and the second loop inductor antenna 345 communications between the source computing device 310 and the receiver computing device 320 may be intercepted by a malicious actor via a computing device (e.g., a malicious actor computing device 360) within a certain vicinity of the original connection 350, where the vicinity may be dependent upon a strength of signal, nearness of an NFC sniffing device, amplification technologies, and/or the like. In some cases, the malicious actor computing device may be physically near an NFC reader device (e.g., the receiver computing device 320, the source computing device 310, or both). The malicious actor computing device 360 may utilize an illicit connection 370 to “sniff” or otherwise intercept information communicated by the source computing device 310, such as a token used to validate a data transaction (e.g., a payment transfer, an authentication data transfer, and/or the like). Once the information from the source computing device 310 is captured via the connection 370, the malicious actor computing device 360 (or another connected computing device) may use the captured information via one or more requests (e.g., multiple requests 380) by requesting a same or similar transaction (e.g., data transfer, payment transaction, authentication event, and/or the like) form the receiver computing device. With the current technology, often such illicit requests may not be stopped or identified allowing the malicious actor to leverage the captured information for illicit activities (e.g., an unauthorized entry to a secure room, an unauthorized payment transaction, and/or the like). For example, the multiple requests 380 from the malicious actor computing device 360 may be multiple illicit payment transaction requests using information captured from an intended payment transaction initiated by the source computing device 310. Because the current technology cannot differentiate between the intended transaction request and the multiple illicit payment transaction requests, the receiver computing device 320 may cause completion of one or more of the illicit payment transaction requests.

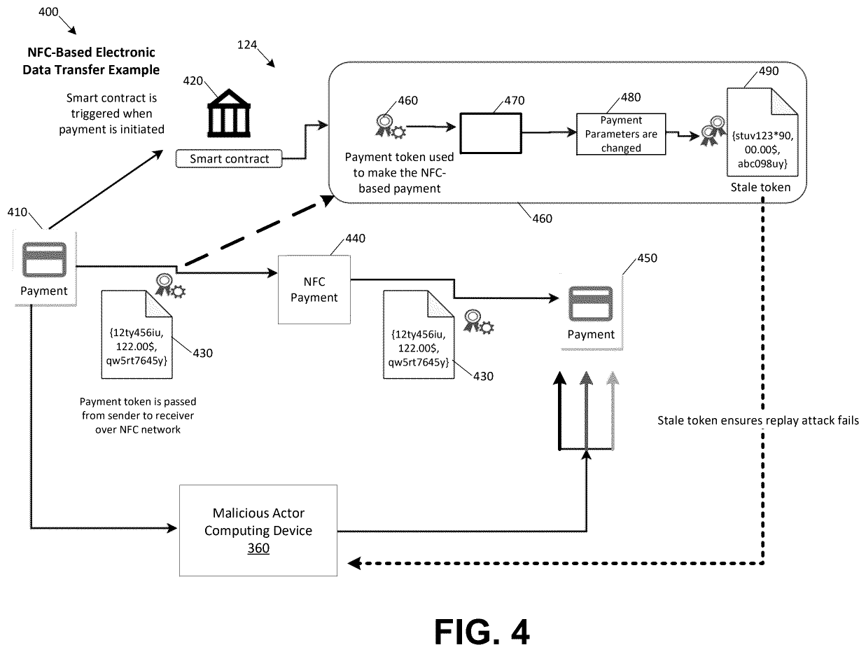

FIG. 4 shows an illustrative block diagram representation of a replay attack prevention process 400 in accordance with one or more aspects described herein. An electronic transaction, such as a data transfer, a file transfer, payment transaction, an authentication event, and/or the like, may be initiated via an NFC connection. While a payment example has been shown in FIG. 4, the shown method and actions may be used with other data transfer types performed over the NFC connection.

In the illustrative block diagram of FIG. 4, a payment initiation event 410 may be initiated via a source computing device (e.g., the source computing device 310) communicating via an NFC network (e.g., the first NFC network 210, the second NFC network 220, the third NFC network 230, and/or the like). As part of the data transfer (e.g., the payment initiation event 410), a token may be created, such as the payment token 430. The payment token 430 may be passed from the sender to the receiver via the NFC connection as part of the NFC data transfer to facilitate a payment transaction 440. Additionally, when the sender initiates a payment (e.g., the payment initiate event 410), a message may be transferred over a private or public communication network (e.g., a telecommunications network, a WIFI network, a local area network, and/or the like). The message may initiate operation of a smart contract 420 to facilitate the particular data transfer event via the NFC network, such as the payment 440. The smart contract may be stored as a block in a blockchain, such as in the distributed ledger system 124, or the like. In some cases, the smart contract may be associated with the payment token 430 that is used to facilitate the payment transaction. As an input, the payment token instance 460 received by the smart contract may be analyzed by functions 470, rules, and/or other actions enabled by the smart contract 420. The functions may analyze the input payment token 460 to determine whether the payment token is active or stale. If active, the functions 470 may trigger completion of the data transfer event at the NFC network. For example, the functions 470, upon identifying a valid payment token 430 may trigger an application computing system 108 (e.g., an electronic payment system) to complete the payment transaction 450 at the receiver device. Parameters passed with or encoded in the payment token may include sender device information, receiver device information, data to be transferred, information that identifies data to be transferred to the receiver device from the sender device and/or from a remote system, (e.g., a payment, authentication information, and/or the like), and/or the like.

Based on the functions 470, parameters of the electronic transaction (e.g., the payment transaction 440) are modified and the smart contract “stales” the payment token 430 based on the modified parameters. As such, if the malicious actor computing device 360 captures the payment token 430 during the NFC-based transaction and attempts to use the payment token 430 at the receiver device to “replay” the completed payment 450

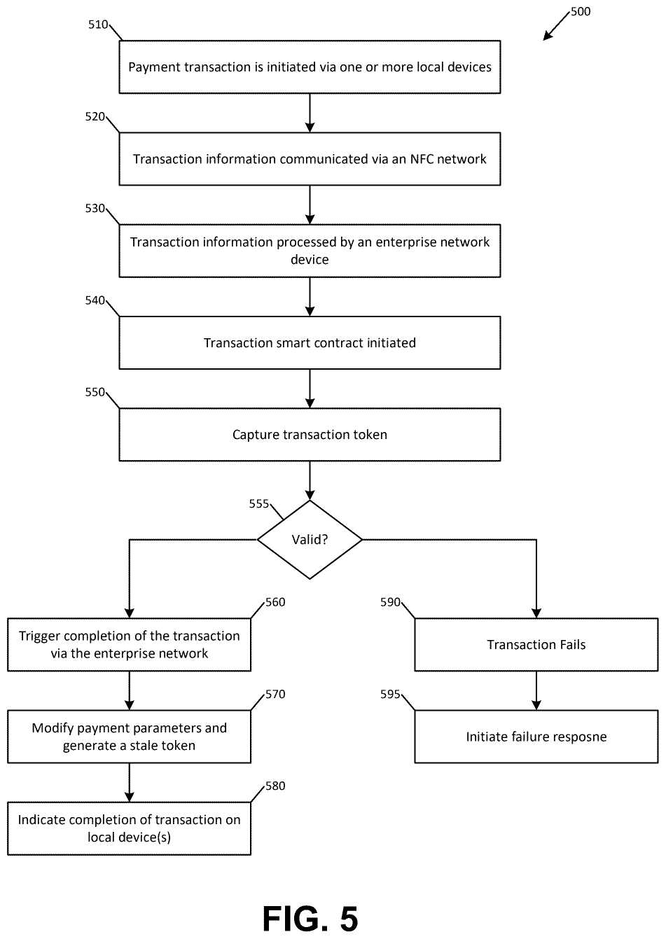

FIG. 5 shows an illustrative process 500 for providing replay attack prevention for NFC-based transactions in accordance with one or more aspects described herein. As discussed above, the illustrative process 500 is discussed with reference to, is but not limited to, an NFC payment transaction. At 510, an NFC payment transaction is initiated by a source computing device, such as the source computing device 310, and with a receiver computing device 320. At 520, data transfer information (e.g., payment information, a token, and the like) may be transferred between the source computing device 310 and the receiver computing device 320 via the NFC network (e.g., the first NFC network 210, the second NFC network 220, the third NFC network 230, and the like). At 530, the transaction information may be processed by an enterprise network device, or other computing device, to prepare the data transfer (e.g., the requested NFC payment) to be executed.

At 540, receipt of the NFC transaction token (e.g., the payment token 430) at an input of a smart contract (e.g., the smart contract 420) initiates processing of the smart contract based on the token, where the smart contract 420 captures the token (e.g., the input payment token 460) at 550. The smart contract processes the captured token at 555 to identify whether the token is valid. If so, the smart contract functions trigger completion of the transaction between the NFC source device and the NFC recipient device and via the enterprise network. For example, the smart contract may trigger an enterprise electronic transaction system to process the payment from an account associated with the source computing device to a second account associated with the receiver computing device. In another example, an authentication event processed via the NFC network may cause an authentication of user information associated with the source computing device and, upon proper authentication, may cause approval and/or other authentication information to be communicated from an enterprise authentication system to a computing system associated with the receiver computing device, such as to cause a secured gateway to be opened, access to information on the receiver computing device, and/or the like. In some cases, proper authentication of the NFC token may cause information, such as a file, to be transferred between the source computing device and the receiver computing device. At 570, the functions may alter NFC transaction parameters (e.g., source device information, a validation flag, receiver information, payment information, data transfer information, user information, and the like) to be modified, such as by resetting a validation flag, modifying data transfer information (e.g., setting a payment amount to zero), modifying the receiver device information and/or the source device information, and/or the like). The smart contract may then cause the NFC token to become stale, such as by generating a new token based on the modified parameters. At 580, the smart contract may trigger completion of the data transfer between the source computing device and the receiver computing device.

If, at 555, the input token is invalid, such as when a captured NFC token has been attempted to be reused during a replay attack, the smart contract processes functions that indicate that a stale token has been attempted to be reused and causes the data transfer (e.g., the authentication event, an NF-based payment transaction, an authentication event, and the like) to fail at 590. In some cases, at 595, the smart contract may trigger an error or other failure response, such as to flag an improper payment request at the electronic transaction system, trigger a security event at the authentication system, and/or may indicate a transaction failure at the receiver device. In some cases, the failure response may cause generation of an alert user interface to be generated at a remote computing device, such as to provide information about the attempted malicious reuse of the token during a replay attack.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A system comprising:
a first computing device having a near-field communication (NFC) functionality, initiating a data transaction via an NFC connection to a second computing device; and
a host computing device comprising;
a processor; and
memory storing computer-readable instructions that, when executed by the processor, cause the host computing device to:
receive, from a first computing device via a network, a token corresponding to the initiated data transaction between the first computing device and the second computing device;
process, based on the token, data transfer parameter information to determine token validity;
trigger, at a second host computing device and based on identification that the token is valid, completion of the data transaction; and
generate, by functionality of a smart contract and in response to triggering completion of the data transaction, a stale token.

2. The system of claim 1, wherein the host computing device comprises a distributed ledger computing system.

3. The system of claim 1, wherein the smart contract is associated with a block in a blockchain corresponding to the first computing device.

4. The system of claim 1, wherein the token is based on data transaction parameters corresponding to a data transaction type, source device information associated with the first computing device, and receiver information corresponding to the second computing device.

5. The system of claim 1, wherein the data transaction comprises an NFC-based payment transaction.

6. The system of claim 1, wherein the data transaction comprises an NFC-based authentication data transaction.

7. The system of claim 6, wherein the instructions cause the host computing device to modify data transaction parameters received with the token, wherein generation of the stale token is based on the modified data transaction parameters.

8. The system of claim 1, wherein the instructions cause the host computing device to trigger, at a remote device, a failure response based on identification that the token is invalid.

9. The system of claim 1, wherein the instructions cause the host computing device to inhibit completion, by the second host computing device, the data transaction based on identification that the token is invalid.

10. A method comprising:
receiving, by a first host computing system and from a first computing device via a network, a token corresponding to an initiated data transaction via near field communication between a first computing device and a second computing device;
processing, by the first host computing system and by a smart contract based on the token, data transfer parameter information to determine token validity;
triggering, by the first host computing system and at a second host computing device and based on identification that the token is valid, completion of the data transaction; and
generating, by the first host computing system and by smart contract functionality and in response to triggering completion of the data transaction, a stale token.

11. The method of claim 10, wherein the host computing device comprises a distributed ledger computing system.

12. The method of claim 10, wherein the smart contract is associated with a block in a blockchain corresponding to the first computing device.

13. The method of claim 10, wherein the token is based on data transaction parameters corresponding to a data transaction type, source device information associated with the first computing device, and receiver information corresponding to the second computing device.

14. The method of claim 10, wherein the data transaction comprises an NFC-based payment transaction.

15. The method of claim 10, wherein the data transaction comprises an NFC-based authentication data transaction.

16. The method of claim 15, further comprising modifying, by the first host computing system, data transaction parameters received with the token, wherein generation of the stale token is based on modified data transaction parameters.

17. The method of claim 10, further comprising triggering, by the first host computing system at a remote device, a failure response based on identification that the token is invalid.

18. The method of claim 10, further comprising triggering, by the first host computing system, the second host computing device to inhibit completion of the data transaction based on identification that the token is invalid.

19. A near field communication (NFC) transaction security computing device comprising;
a processor; and
memory storing computer-readable instructions that, when executed by the processor,
cause the NFC transaction security computing device to:
receive, from a first computing device via a network, a token corresponding to an initiated NFC data transaction between the first computing device and a second computing device;
process, based on the token, data transfer parameter information to determine token validity;
trigger, at a second host computing device and based on identification that the token is valid, completion of the NFC data transaction; and
generate, by smart contract functionality and in response to triggering completion of the NFC data transaction, a stale token.

20. The NFC transaction security computing device of claim 19, wherein the instructions cause the NFC transaction security computing device to inhibit completion, by the second host computing device, the data transaction based on identification that the token is invalid.
